(19) United States
(12) Patent Application Publication
(10) Pub. No.: US 2010/0033743 A1
(43) Pub. Date: Feb. 11, 2010

(54) IMAGE FORMING APPARATUS, PRINT MEDIA TRANSPORT DEVICE, AND IMAGE QUALITY DETERMINING METHOD

(76) Inventor: Shuji Hirai, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/537,791

(22) Filed: Aug. 7, 2009

(30) Foreign Application Priority Data
Aug. 8, 2008 (JP) 2008-206051

(51) Int. Cl. H04N 1/60

(52) U.S. Cl. 358/1.9

(57) ABSTRACT

An image forming apparatus includes an image forming unit, an image sensor unit, an image data obtaining unit, and an image quality determiner unit to determine quality of an image on a print sheet after fusing based on input image data and output image data as a result of detection by the image sensor unit. According to a result of the determination, a print sheet containing an image determined as a non-normal image is discharged to a first paper tray while that containing an image determined as a normal image is discharged to a second paper tray.

### CROSS REFERENCE TO RELATED APPLICATION

The present application is based on and claims priority from Japanese Patent Application No. 2008-206051, filed on Aug. 8, 2008, the disclosure of which is hereby incorporated by reference in its entirety.

### BACKGROUND OF THE INVENTION

1. Field of the Invention

The present invention relates to an image forming apparatus, a print media transport device, and an image quality determining method.

2. Description of the Related Art

Generally, an image forming apparatus such as a copier or a printer is configured to form an image on a print medium by forming a latent image on a photoconductor based on image data, forming a toner image from the latent image with a develop unit, and transferring the toner image onto the print medium with a transfer unit to fuse it with a fuser unit. There is a problem in such an image forming apparatus that it may generate defective images with white spots or undesirable lines due to a transfer failure or the like, which causes a user to check every print medium on a paper tray for a defective image. In an image forming apparatus for use in mass production printing, users' load for the checkup will be enormous. Thus, there has been a demand for an image forming apparatus having a function to automatically check quality of output images and selectively remove defective images.

Japanese Unexamined Patent Application Publication No. 2003-327345 (Reference 1) discloses an image forming apparatus which is configured to detect a position of an image on a print medium to discharge the print medium as a defective sheet to a different destination from a regular destination when the image position is shifted from the standard position over a threshold. Further, Japanese Unexamined Patent Application Publication No. 2006-84822 (Reference 2) discloses an image forming apparatus which is configured to measure image quality factors such as developer toner concentration, toner image concentration on photoconductor, photoconductor surface potential, not-fused and fused toner image concentrations on a print medium, and registration accuracy on a print medium to determine an image quality level on the print medium based on these factors and discharge print media containing high quality images and print media containing low quality images to different destinations according to results of determination.

Both of the apparatuses in References 1 and 2 discharge print media containing images with great positional shifts or low quality image to a different destination from a destination to which print media containing normal images are discharged. This eliminates the necessity for a user to visually check image quality of every print medium, and accordingly can reduce users' load and their checkup errors. Also, in mass production printing, such apparatuses achieve more satisfiable results for commercial printers and can improve their clients' satisfaction due to less defective outputs.

However, there still remains a problem that since the apparatus in Reference 1 detects only positional shifts of images so that defective images without positional shifts but with image density variation or unintentional lines or white spots are discharged to the same destination to which normal images are discharged. Accordingly, print media containing normal images and those containing defective images are mixed.

With regard to Reference 2, the apparatus is configured to determine image quality level based on the measured image quality factors and data on image quality pre-acquired through tests and associated with the image quality factors. Because of this, it can detect anomaly of image concentration in the entire image; however, it cannot determine defective images including unintended lines, white spots, color shifts or the like as non-normal images. Therefore, print media containing defective images including unintended lines, white spots, or color shifts are discharged to the same destination to which print media containing normal images are discharged, so that accurate image quality determination is unfeasible. Since the unintended lines are linear images formed in positions where images are not to be formed, occurrence of an unintended line in an output image cannot be determined unless an output image is compared with an input image. Similarly, white spots occur when images are not formed in positions where they are supposed to be formed so that an image with white spots can be determined as defective unless an output image is compared with an input image. Likewise, relative to color shifts, whether or not color shades of an output image represent original color shades cannot be determined without the comparison of the output and input images.

### SUMMARY OF THE INVENTION

The present invention aims to provide an image forming apparatus, a print media transport device, and an image quality determining method which can realize accurate determination of image quality.

According to one aspect of the present invention, an image forming apparatus comprises an image forming unit which forms an image on a print medium based on image data; an image detector unit which detects the image on the print medium; an image data obtaining unit which obtains the image data; and an image quality determiner unit which determines quality of the image on the print medium based on the image data obtained by the image data obtaining unit and a result of detection by the image detector unit.

In one features of the above aspect, the image forming apparatus further comprises a normal print medium receiver to which a print medium on which an image determined as a normal image by the image quality determiner unit is recorded is discharged; a non-normal print medium receiver to which a print medium on which an image determined as a non-normal image by the image quality determiner unit is recorded is discharged; and a switching unit which switches destinations of the discharge of a print medium under transportation between the normal image print medium receiver and the non-normal image print medium receiver based on a result of determination by the image quality determiner unit.

In the other features of the above aspect, a distance from the image detector unit to the switching unit in which the print medium is transported is set to be longer than a length of a print medium in a transport direction which is of a maximum size usable in the image forming apparatus.

In the other features of the above aspect, the image forming apparatus further comprises a substitute print medium container unit which contains a substitute print medium which is different in shape and/or color from the print medium, wherein the image forming apparatus is configured to discharge, during a continuous imaging operation in which images are continuously formed on a plurality of print media, the substitute print medium to the normal image print medium receiver in replace of the print medium on which the image determined as the non-normal image by the image quality determiner unit is recorded.

In the other features of the above aspect, the image forming apparatus further comprises a temporary stack unit in which the print medium is temporarily stacked, wherein when the image quality determiner unit determines an image as a non-normal image during a continuous imaging operation in which images are continuously formed on a plurality of print media, the image forming apparatus is configured to temporarily stack, in the temporary stack unit, a print medium on which the determined non-normal image is recorded and a print medium on which an image subsequent to the determined non-normal image is formed, temporarily stop the continuous imaging operation, form the determined non-normal image again on a print medium and discharge the print medium to the normal image print medium receiver, and thereafter transport the print media stacked in the temporary stack unit and resume the continuous imaging operation.

In the other features of the above aspect, the image forming apparatus is configured to discharge, to the normal print medium receiver, the print medium on which the non-normal image determined by the image quality determiner unit is recorded such that the print medium containing the non-normal image is displaced in a direction orthogonal to a transport direction from the print medium on which the normal image determined by the image quality determiner unit is recorded.

In the other features of the above aspect, the image forming apparatus is configured to stop a continuous imaging operation when the image quality determiner unit continuously determines a predetermined number of images as non-normal images during the continuous imaging operation in which images are continuously formed on a plurality of print media.

In the other features of the above aspect, the image quality determiner unit is configured to divide the image data obtained by the image data obtaining unit into a plurality of areas and calculate a feature amount in each area, to divide the image on the print medium into a plurality of areas and calculate a feature amount in each area, and to determine quality of the image on the print medium based on a result of comparison between the feature amount of the image data and the feature amount of the image on the print medium.

In the other features of the above aspect, the image forming apparatus further comprises a storage unit which stores a result of determination by the image quality determiner unit.

According to another aspect of the present invention, a print media transport device comprises a print media transport unit which transports a print medium on which an image is formed; an image detector unit which detects the image on the print medium; an image data obtaining unit which obtains image data for forming an image on the print medium; and an image quality determiner unit which determines quality of the image on the print medium based on the image data obtained by the image data obtaining unit and a result of detection by the image detector unit.

According to another aspect of the present invention, an image quality determining method to detect an image on a print medium to determine a quality of the image comprises the steps of forming an image on a print medium based on image data; detecting the image on the print medium; obtaining the image data; and determining quality of the image on the print medium based on the obtained image data and a result of the image detection.

### BRIEF DESCRIPTION OF THE DRAWINGS

FIG. 1 schematically shows structure of a copier as an example of an image forming apparatus according to a first embodiment of the present invention.

FIG. 2 schematically shows a control unit of the copier.

FIG. 3 is a schematic view for describing feature extraction.

FIG. 4 is a schematic view for describing feature extraction from areas set in a minute size.

FIG. 5 schematically shows structure of a copier as an example of an image forming apparatus according to a second embodiment of the present invention.

FIG. 6 schematically shows structure of a copier as an example of an image forming apparatus according to a third embodiment of the present invention.

FIG. 7 schematically shows structure of a copier as an example of an image forming apparatus according to a fourth embodiment of the present invention.

FIG. 8 is a flowchart for control over a continuous printing according to the fourth embodiment.

FIG. 9 schematically shows structure of another copier according to the fourth embodiment.

FIG. 10 shows the essential part of a copier according to a fifth embodiment.

FIG. 11 schematically shows structure of a color image forming apparatus of a tandem direct transfer type.

### DETAILED DESCRIPTION OF PREFERRED EMBODIMENTS

### First Embodiment

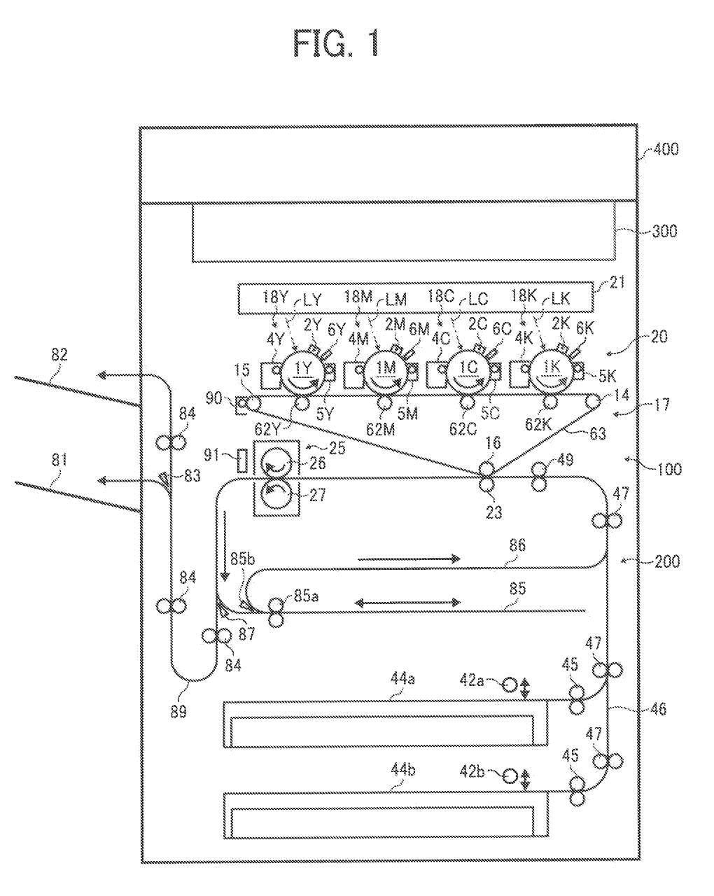

Hereinafter, embodiments of the present invention will be described in detail with reference to the accompanying drawings. A tandem type color laser copier (hereinafter, copier) in which a plurality of photoconductors are arranged in tandem will be described as an example of an image forming apparatus to which the present invention is applied. FIG. 1 schematically shows a copier according to the first embodiment. The copier comprises a printer unit 100, a feeder unit 200, a scanner unit 300, and an automatic document feeder 400 secured on the scanner unit 300.

The printer unit 100 as an image forming unit comprises an imaging unit 20 of four process cartridge 18Y, 18M, 18C, 18K to form four color images (yellow (Y), magenta (M), cyan (C), black (K)) and an intermediate transfer unit 17. Note that hereinafter, elements relative to the four colors will be given reference numerals having Y, M, C, K at the end.

An optical write unit 21 is provided above the imaging unit 20 and comprises a not-shown light source, a polygon mirror, an f-θ lens, a reflective mirror and the like to radiate laser light onto the surface of later-described photoconductors based on image data.

Next, the yellow color process cartridge 18Y is described. The process cartridge 18Y comprises a photoconductor drum 1Y, an electric charger 2Y, a developer unit 4Y, a drum cleaner 5Y, and a neutralizer 6Y. The electric charger 2Y uniformly charges the surface of the photoconductor drum 1Y to which laser light modulated or deflected by the optical write unit 21 is radiated after the charging process. Then, a portion of the surface radiated (exposed portion) is attenuated. By this attenuation, an electrostatic latent image for yellow is generated on the surface of the photoconductor drum 1Y. The generated yellow color electrostatic latent image is developed with the developer 4Y to be a yellow toner image. The yellow toner image on the photoconductor drum 1Y is primarily transferred onto a later-described intermediate transfer belt 63. After the primary transfer, residual toner is cleaned from the surface of the photoconductor drum 1Y by the drum cleaner 5Y. In the process cartridge 18Y, the cleaned photoconductor drum 1Y is neutralized by the neutralizer 6Y such as a quenching lamp and uniformly charged by the electric charger 2Y to return to the initial state. A series of processing above are also performed for the rest of the process cartridges 18M, 18C, 18K.

Next, the intermediate transfer unit 17 is described. It comprises an intermediate transfer belt 63, a belt cleaner 90, a tension roller 14, a drive roller 15, a secondary transfer backup roller 16, four primary transfer bias rollers 62Y, 62M, 62C, 62K, and a secondary transfer roller 23. The intermediate transfer belt 63 with no ends is extended with tension via a plurality of rollers including the tension roller 14 and moved clockwise in the drawing by rotation of the drive roller 15 driven by a not-shown belt drive motor. The four primary transfer bias rollers 62Y, 62M, 62C, 62K are disposed to contact with the inner surface of the intermediate transfer belt 63 and be applied with a primary transfer bias from a not-shown power source. Also, the intermediate transfer belt 63 is pressed from the inner surface side towards the photoconductor drums 1Y, 1M, 1C, 1K to create respective primary transfer nips. A primary transfer electric field is generated in each primary transfer nip between each photoconductor drum 1 and each bias roller 62 due to the primary transfer bias. The above yellow color toner image on the photoconductor drum 1Y is primarily transferred on the intermediate transfer belt 63 by the primary transfer electric field and nip pressure. Then, magenta, cyan, black color toner images on the photoconductor drums 1M, 1C, 1K are primarily transferred and superimposed on the yellow color toner image in sequence. By such primary transfer, a superimposed four color toner image (hereinafter, four color toner image) is formed on the intermediate transfer belt 63.

The secondary transfer roller 23 contacts with the outer surface of the intermediate transfer belt 63 to form a secondary transfer nip. It is applied with a secondary transfer bias by a not-shown secondary transfer power source while the secondary transfer backup roller 16 is grounded. This forms a secondary transfer electric field between the secondary transfer backup roller 16 and the secondary transfer roller 23. The four color toner image on the outer surface of the intermediate transfer belt 63 enters the secondary transfer nip along with the movement of the no-end intermediate transfer belt 63 and is secondarily transferred onto a not-shown print sheet as a print medium. After passing the secondary transfer nip, residual toner on the intermediate transfer belt 63 is cleaned by the belt cleaner 90 which is provided to sandwich the belt with the drive roller 15 on the right side in the drawing.

The feeder unit 200 comprises two-stage cassettes 44a, 44b which can contain a stack of print sheets and are arranged in two stages in a vertical direction. The topmost sheets of the stacks are pressed by feed rollers 42a, 42b in the cassettes 44a, 44b, respectively so that the topmost sheets are transmitted to a feed path 46 by rotation of the feed rollers 42a, 42b.

The feed path 46 receiving the print sheets transmitted from the cassettes 44a, 44b includes a plurality of transport roller pairs 47 and a resist roller pair 49 which is disposed near the end of the feed path 46, to transport the print sheets to the resist roller pair 49. Then, the print sheets are placed between the resist roller pair 49. Meanwhile, the four color toner image on the outer surface of the intermediate transfer belt 63 enters the secondary transfer nip along with the movement of the no-end intermediate transfer belt 63 in the intermediate transfer unit 17. The resist roller pair 49 emits the print sheets at the right timing to be able to get the four color toner image affixed to the print sheets. Accordingly, the four color toner image on the intermediate transfer belt 63 is affixed to the print sheets in the secondary transfer nip, and secondarily transferred thereon to form a full color image on the white print sheets. After the secondary transfer nip, the print sheet with the full color image thereon is transported to a fuser unit 25.

The fuser unit 25 comprises a fuse roller 26 and a pressure roller 27 pressed to the fuse roller 26 which are in close contact with each other to form a fuse nip into which print sheets are inserted. The fuse roller 26 incorporates a not-shown heat source to emit heat and heat up the print sheet in the fuse nip. The full color image is fused on the print sheet by the heat and nip pressure.

Under the fuser unit 25, a switchback 85, a reverse path 86 and a first switching pawl 87 are provided. The first switching pawl 87 is turnable to switch the transport path. The print sheet from the fuser unit 25 is delivered to a discharge path 89 or the switchback 85 according to the position of the first switching pawl 87. The print sheet delivered to the discharge path 89 is transported via a discharge roller pair 84 to outside and stacked on a first paper tray 81 or a second paper tray 82.

Meanwhile, the print sheet delivered to the switchback 85 is transported to the reverse path 86 by reverse rotation of a reverse roller pair 85a of the switchback 85 and turning of a reverse switching pawl 85b. Thus, it is vertically reversed by the switchback 85 and then transported to the resist roller pair 49 again to re-enter the secondary transfer nip, thereby forming a full color image on another side of the print sheet.

To make a copy of not-shown documents, for example, a bundle of original sheet documents are placed on a not-shown platen of the automatic document feeder 400. Book-type bound documents are placed on a not-shown platen glass. The automatic document feeder 400 is opened from the copier to expose the not-shown platen glass of the scanner unit 300 on which the bound documents are placed. Then, the documents are pressed down with the closed automatic document feeder 400.

Upon a copy start switch on a not-shown operation panel being pressed, the scanner unit 300 starts reading the documents. Sheet documents on the automatic document feeder 400 are automatically moved to the platen by the automatic document feeder 400 before reading.

In parallel with such reading operation, elements in the respective process cartridges 18Y, 18M, 18C, 18K, the intermediate transfer unit 17, and the fuser unit 25 start operating. The optical write unit 21 is controlled to form yellow, magenta, cyan, black toner images on the photoconductor drums 1Y, 1M, 1C, 1K respectively, based on image data read by the scanner unit 300. These toner images are transferred and superimposed to be the four color image on the intermediate transfer belt 63.

Almost concurrently with start of the document reading operation, the feeder unit 200 starts a feeding operation. In this feeding operation, one of the feed rollers 42a, 42b is selectively rotated to emit print sheets from either of the cassettes 44a, 44b. The emitted print sheets are separated from one another by either of separation roller pairs 45, enter the reverse feed path 46 and are transported to the secondary transfer nip via the transport roller pairs 47.

To form multi-color toner images of two or more toner colors with the copier of the present embodiment, all the photoconductor drums 1Y, 1M, 1C, 1K are brought into contact with the upper surface of the intermediate transfer belt 63 while the intermediate transfer belt 63 is tensioned to be substantially horizontal. On the other hand, to form monochrome images of a black toner, the upper surface of the intermediate transfer belt 63 is separated from the photoconductor drums 1Y, 1M, 1C while the intermediate transfer belt 63 is inclined leftward in the drawing. Then, only the photoconductor drum 1K is rotated counterclockwise to form a black toner image. Here, not only the photoconductor drums 1Y, 1M, 1C but also the developer units 4Y, 4M, 4C stop operating, thereby preventing extraneous consumption of photoconductor drums or developers.

In the present embodiment, the copier is configured to include, near the fuser unit 25, an image sensor unit 91 as an image detector unit which detects an image on a print sheet after fusing. The image sensor unit 91 can be a CCD (Charge Coupled Device) or a CMOS (Complementary Metal Oxide Semiconductor) in which image sensors are linearly arranged in the width direction of a print sheet, and it can two-dimensionally detect image information.

The copier according to the present embodiment determines image quality on the print sheet after fusing based on image data and a detection result from the image sensor unit 91. According to the detection result, a print sheet on which an image determined as non-normal is formed is discharged to the first paper tray 81 as a non-normal image print medium receiver while a print sheet on which an image determined as normal is formed is discharged to the second paper tray 82 as a normal print medium receiver. Specifically, a later-described image quality determiner unit determines image quality, and upon its determining an image as non-normal, a second switching pawl 83 as a switching unit is turned so as to discharge the print sheet containing the non-normal image to the first paper tray 81. Oppositely, upon determining an image as normal, a second switching pawl 83 as a switching unit is turned so as to discharge the print sheet containing the normal image to the second paper tray 82.

Also, a discharge path 89 is set to largely meander and be longer than a length in a transport direction of a print sheet of a maximum size useable in the copier. This makes it possible to prevent the top end of the print sheet from reaching the second switching pawl 83 before the image sensor unit 91 completes detection of the bottom end of the print sheet. This allows the image quality determiner unit to determine image quality based on the image sensor unit 91's detection of the top to bottom ends of the print sheet, and the second switching pawl 83 to be controlled according to a result of the determination before the top end of the print sheet reaches the second switching pawl 83. Accordingly, it is made possible to discharge print sheets on which defective images are formed to the first paper tray 81 without fail. Although the discharge path 89 meanders downwards in FIG. 1, the present invention is not limited thereto. The discharge path 89 can be formed arbitrarily, for example, to meander upwards, or to turn back in a horizontal direction, or to be a long straight line in a lateral direction as long as it is long enough to function.

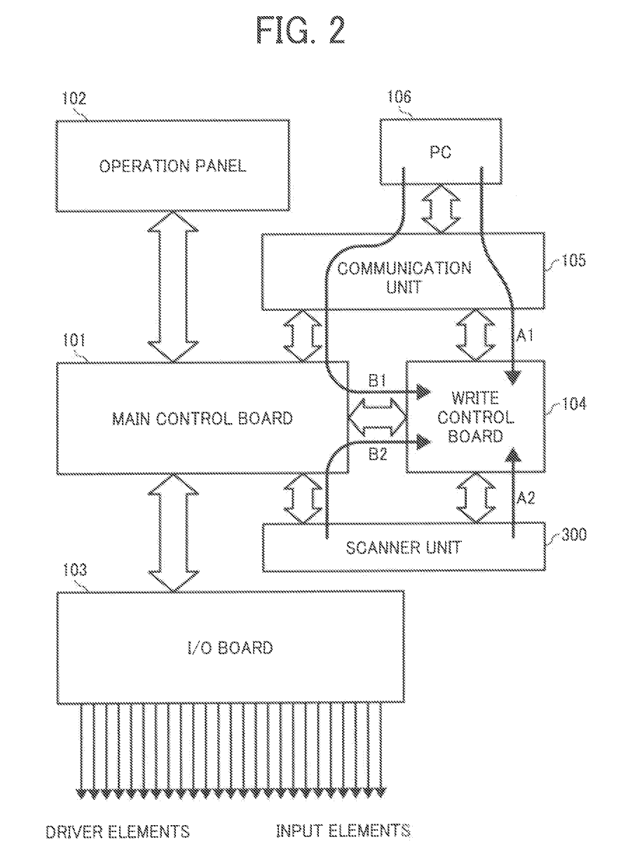

FIG. 2 schematically shows a control unit of the copier according to the present embodiment. The control unit comprises a main control board 101 and various boards to perform various functions. The main control board 101 is connected with a communication unit 105 which is communication means to perform data communication with a PC (personal computer) 106 as an external device, and with a write control board 104 to control the write unit 21 based on image data. The main control board 101 is also connected with an operation panel 102 and the scanner unit 300. Not-shown driver units for the image sensor unit 91 and first switching pawl 87 and for the second switching pawl 83 are connected with the main control board 101 via an I/O board 103 including a driver, an input circuit or the like.

The main control board 101 includes a CPU (Central Processing Unit), memories as RAMs (Random Access Memories) and ROMs (Read Only Memories), various processing circuits and arithmetic circuits and else.

How to transmit image data from the PC 106 or the scanner unit 300 (hereinafter, input image data) to the write control board 104 is determined depending on the design of an electric circuit board. However, generally, it is transmitted not via the main control board 101 (arrows A1 and A2 in the drawing). In detail, the input image data transmitted from the PC 106 is received at the communication unit 105 and transmitted to the write control board 104. The input image data read by the scanner unit 300 is transmitted to the write control board 104. This is because the input image data is large in amount and need not be transmitted via the main control board 101. However, it is needless to say that the input image data can be transmitted via the main control board 101 as indicated by arrows B1, B2 in the drawing. Alternatively, it can be transmitted via a not-shown third board to the write control board 104.

In the present embodiment, the input image data are collected and stored in memories on the main control board 101 or another board controlled by the main control board 101 during transmission of the input image data to the write control board 104 or from the write control board 104 after the transmission. That is, the CPU on the main control board 101 and the memories storing the input image data and else constitute an image data obtaining unit. In detail, when the input image data are directly transmitted to the write control board 104 (the arrows A1, A2 in the drawing) not via the main control board 101, the input image data are collected from the write control board 104, transmitted to the main control board 101 and stored in the memories. When the input image data are transmitted to the write control board 104 via the main control board 101 (the arrows B1, B2 in the drawing), the input image data are stored in the memories while they are passing the main control board 101.

The input image data have to be reduced in amount before stored in the memories since storing raw data requires a large amount of memory areas and causes a delay in processing speed of the subsequent image determination. The input image data are to be compressed before stored or only extracted feature amount data (later described) used for determining image quality (such as number of pixels in each area or area rate, estimated color tone value from number of pixels in each color) are to be stored in the memories.

Furthermore, relative to image data input from the image sensor unit 91, corresponding to an image on a print sheet (hereinafter, output image data), they are input to the main control board 101 via the I/O board or via a not-shown dedicated analog data processing circuit board. The output image data can be stored in the memories; however, it is preferable to directly use them in the image quality determination without storing in the memories since it requires a large amount of memory areas.

Image quality is determined by comparing an extracted feature amount of the output image data and that of input image data stored in the memory by an arithmetic comparator circuit. Specifically, in accordance with a timing when the output image data is input to the main control board 101, the input image data is read from the memory. Then, the input and output image data are concurrently processed by processing circuits, respectively and their feature amounts are extracted. An arithmetic comparator circuit compares the extracted feature amounts of the input and output image data. This image quality determination is executed by a later-described image quality determiner unit. Needless to say that in the above processing, the feature extraction from the input image data after data readout can be omitted when it is extracted in advance and stored in the memory. The above feature extraction processing and arithmetic comparison are assumed to be executed by hardware circuitry. This is because it is very difficult to process a very large amount of image data by software in terms of time. However, they can be done by software when advanced software becomes available in the future. As described above, according to the present embodiment, the CPU and its peripheral elements as the memories, processing circuit and arithmetic comparator circuit on the main control board 101 constitute the image quality determiner unit.

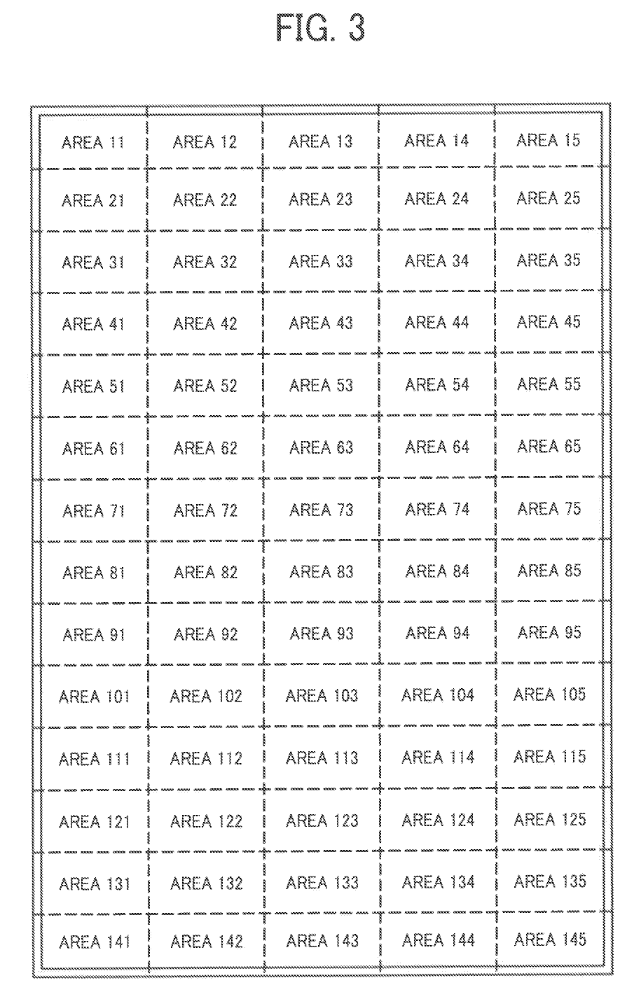

Next, feature extraction from the input and output image data will be described in detail. FIG. 3 is a schematic view to describe feature extraction. As shown in the drawing, the image data is divided into a plurality of data areas and feature amount is extracted from each data area. According to the present embodiment, color tone (R, G, B signals) in each area is extracted as feature amount. The feature amount of the input image data is extracted in the following manner. First, the numbers of pixels in yellow, magenta, cyan, and black in each data area are extracted as input image data from pixel number data in yellow, magenta, cyan, and black in the write control board 104. Color of the data area is determined in accordance with the respective numbers of four color pixels present in the area. It is possible to approximately estimate the color of each data area of a minute size by counting the number of each of the four color pixels in the area. However, it is not possible to estimate it in a large size data area only from the pixel numbers since different color may appear in different portion of the area. Basically, the color of each data area can be estimated from a ratio of four color pixels and the total number of written pixels in the area.

In detail, the copier can include a lookup table showing a relation between four color pixel number data in each data area and color tone data (R, G, B signals) which is acquired in advance through tests or the like. Accordingly, color tone of each data area of the input image data can be estimated based on extracted numbers of four color pixels in each data area and the lookup table. In the image data division shown in FIG. 3, feature amounts of 5 x 14 (estimated color tone value) are stored in the memories.

Meanwhile, the feature amount of each data area of the output image data is extracted by calculating the color tone value in each data area based on the output image data detected by the image sensor unit 91.

Next, image quality determination will be described. The image quality determination according to the present embodiment is done by dividing an image into areas and comparing color tones of the divided areas. That is, an estimated color tone value of one area of the input image data and a color tone value of the same area of the output image data are compared with each other. With a large difference in between the two values, the image in that area is determined to be defective.

For example, assumed that a color tone value is set such that it represents white when R=G=B=100 and it represents black when R=G=B=0. When an estimated color tone value of one area based on the input image data is R=100, G=100, B=100, for example, an output image on a print sheet corresponding to this area will be blank. However, when a detected value of this area from the image sensor unit 91 is R=80, G=20, B=5, the image will be reddish so that there is a color shift in the output image relative to the input image. It can be estimated that a transfer failure has occurred in a specific color. Further, when a defected value of this area from the image sensor unit 91 is R=0, G=0, B=0, it can be determined that an output image corresponding to this area will include a defect such as smudges.

As above, it is possible to decide whether or not a defective image occurs by dividing an image into areas (preferably, areas of minute size) and comparing color tones of the divided areas.

In the above description, the color tone of an area is estimated from pixel numbers of the four colors in that area extracted as input image data from the pixel number data of the four colors stored in the write control board 104. However, the present embodiment is not limited thereto. The color tone can be estimated in each area from image data composed of R, G, B signals before converted into the pixel number data of the four colors. Alternatively, an image area rate of each of the four colors in one area can be calculated from input image data to estimate the color tone in that area from a proportion of the image area rates.

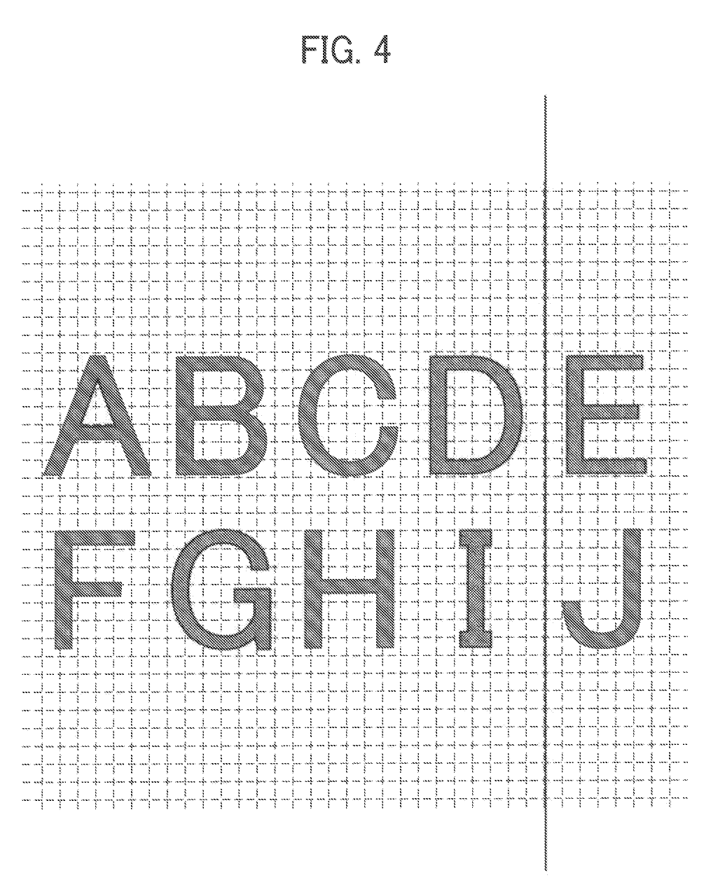

Furthermore, dividing an image into further smaller areas as shown in FIG. 4 makes it possible to detect a defect in an image such as longitudinal lines. When an image is a monochrome image of characters as in FIG. 4, an estimated color tone value of the areas of the characters is R=G=B=50, for example. This means that a black color occupies a half of the area. That is, for monochrome images, the color tone value is a black color toner concentration. Note that generally, a color tone value of a monochrome image is R=G=B. Also, with regard to areas non including the characters, the color of the areas is generally completely white although it depends on the color of a print sheet so that an estimated color tone value based on input image data will be R=G=B=100. On the other hand, at occurrence of a longitudinal line as in FIG. 4, a detected value of the areas including the line from the image sensor unit 91 is R=G=B=30, i.e., a black color occupies 70% of the areas while an estimated color tone value of the areas is R=G=B=50, i.e., a black color occupies a half of the areas, for example. Thus, an image defect as unintended lines can be detected from such a difference in the values. In a case where a difference in the values appears only in the periphery of the characters, it can be determined that the image of the characters is widen or blurred, deteriorating image quality. When a certain degree of toner concentration is continuously detected in areas including no characters, occurrence of unintended lines can be determined. Further, occurrence of other color lines than black lines can be determined when the values of R, G, B are unbalanced.

Further, when a detected value of areas is R=G=B=100 relative to an estimated color tone value thereof being R=G=B=50, it can be determined that white spots occur in that area.

As described above, in the present embodiment, the input image data and the output image data are compared with each other to determine the image quality. Accordingly, it is possible to accurately determine non-normal images such as unintended lines, widen or blurred characters, white spots, or color tone failures in output images.

When an image on a print sheet is determined to be defective in color tone, concentration, or an unintended line, the main control board 101 controls a not-shown drive unit via the I/O board 103 to drive the second switching pawl 83 and switch the discharge path of the print sheet to one to the first paper tray 81. The print sheet containing the defective image is discharged to the first paper tray 81 different from the second paper tray 82 to which print sheets with normal images are discharged. This can eliminate the necessity for a user to visually check image quality of every one of discharged sheets and reduce the load on the user.

### Second Embodiment

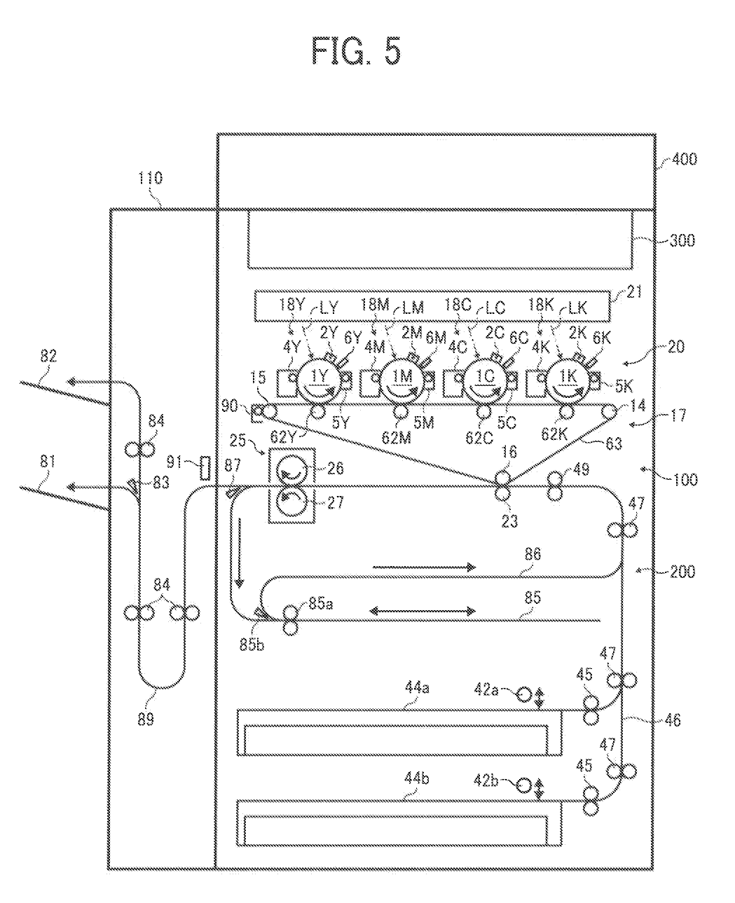

Now, an image forming apparatus according to a second embodiment will be described. FIG. 5 schematically shows the image forming apparatus (copier). The copier in FIG. 5 comprises a post-processing unit 110 (on the left side in the drawing) which includes the image sensor unit 91 near a sheet feed-in portion of the post-processing unit 110. A print sheet discharged from the copier is fed into the post-processing unit 110 and an image thereon is detected by the image sensor unit 91. The detected image is compared with acquired input image data to determine quality of the image. Determined as a non-normal image, the print sheet is discharged to the first paper tray 81 via the turned second switching pawl 83.

Thus, it is preferable to provide the post-processing unit 110 optionally to execute image quality determination processing. This allows a user to selectively use an automatic paper tray selecting function based on image quality determination when needed. The post-processing unit 110 can be configured to include memories in which input image data are stored, an extraction circuit extracting the feature amounts from the input and output image data, and an image determination board as an image quality determiner unit having an arithmetic circuit for comparatively calculating the input and output image data.

### Third Embodiment

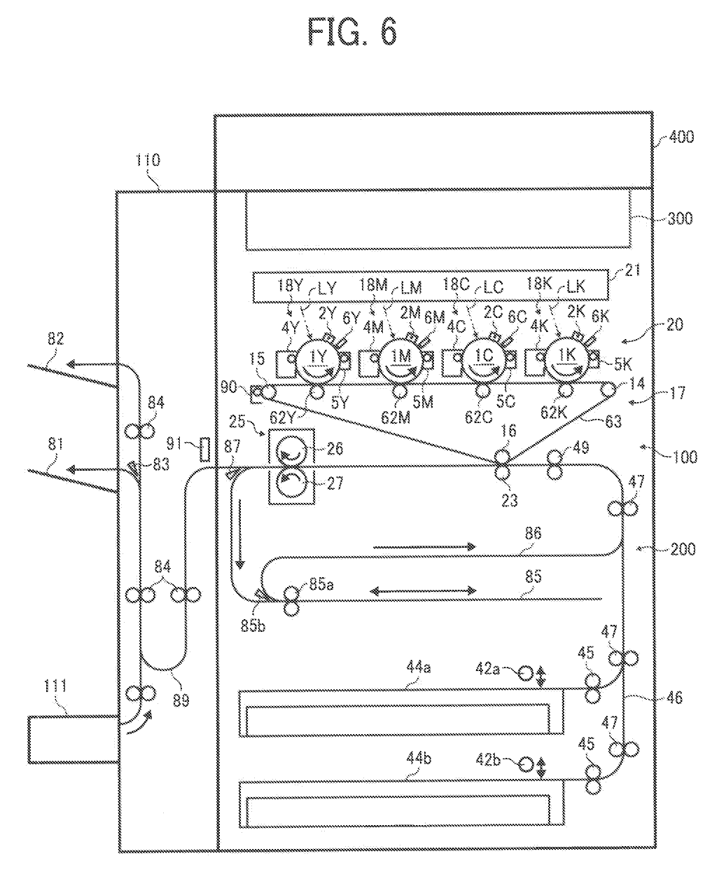

FIG. 6 schematically shows an image forming apparatus according to a third embodiment. The image forming apparatus (copier) is configured to include a post-processing unit 110 having a substitute sheet container unit 111 which contains substitute sheets as a substitute print medium different from the print sheets in shape or color, and discharge the substitute sheets to the second paper tray 82 during continuous printing operation instead of print sheets with determined non-normal images.

Specifically, when the image quality determiner unit determines an image as a non-normal image, a substitute sheet is inserted between a print sheet containing the non-normal image and a subsequent print sheet. After the bottom end of the print sheet containing the non-normal image passes the second switching pawl 83, the second switching pawl 83 is turned to transport the substitute sheet to the second paper tray 82.

The substitute sheets in the substitute sheet container unit 111 can be color sheets for example, and the size thereof does not have to be the same as that of sheets being output presently. The substitute sheet is inserted only as a mark for indicating on what page of sheets an image is found defective and that the sheet is discharged to the second paper tray 82. It can be inserted as a bookmark. Moreover, it is preferable to use a substitute sheet larger in width than the print sheet so that the substitute sheet is slightly protruded from a stack of print sheets discharged on the second paper tray 82. This makes it easier for a user to recognize the page on which a defective image has occurred. Also, since the substitute sheet is inserted between the print sheet containing the non-normal image and a subsequent print sheet, a length thereof has to be short so as not to fill the space between the two sheets. However, a too short substitute sheet is difficult to transport in connection with the interval of the discharge roller pairs 84. In this case, it is preferable to increase the speed of the discharge roller pairs 84 after the image sensor unit 91 reads an image so as to widen the space between print sheets transported and transport a substitute sheet of a certain length.

The copier in FIG. 6 is configured to feed substitute sheets from the discharge path 89 between the image sensor unit 91 and the second switching pawl 83. The present embodiment is not limited to such a configuration. For example, substitute sheets can be fed from the transport path between the second switching pawl 83 and the second paper tray 82. This eliminates the necessity to insert a substitute sheet between the print sheet containing the non-normal image and the subsequent print sheet and makes it possible to transport the substitute sheet at the timing when the image quality determiner unit determines an image as a non-normal image. Accordingly, it is unnecessary to perform a complex control over discharging print sheets such as increasing the speed of the discharge roller pairs 84 to widen the space between the print sheets after the image readout of the image sensor unit 91.

### Fourth Embodiment

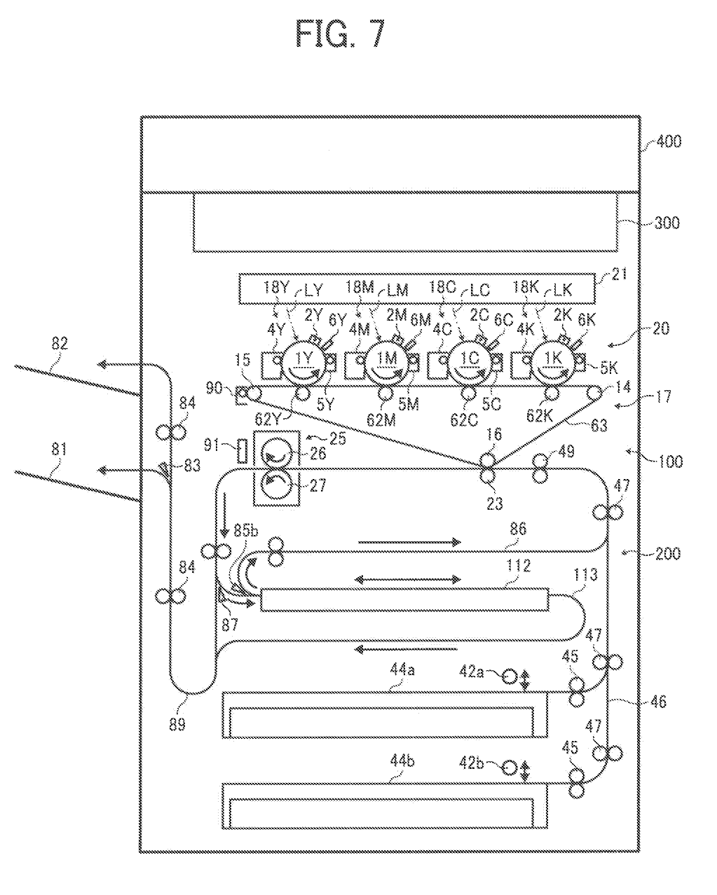

FIG. 7 schematically shows an image forming apparatus (copier) according to a fourth embodiment. As shown in the drawing, the copier in the fourth embodiment comprises a stack area 112 as a temporary stack unit in which a print sheet containing a non-normal image and subsequent print sheets are temporarily stacked when the image quality determiner unit determines an image as a non-normal image during continuous printing operation.

In the copier shown in the drawing, the stack area 112 is configured to be also used for a switchback unit. That is, for reverse transportation, a print sheet is reversely transported to the reverse path 86 after transported to the stack area 112. A print sheet temporarily stacked in the stack area 112 is transported to a re-transport path 113. Thus, the print sheet temporarily stacked in the stack area 112 is not switched back but transported to the re-transport path 113 so that there is no occurrence that a print sheet is discharged to the paper tray with its front and back reversed. Accordingly, a stack of print sheets are discharged to the second paper tray 82 in the right order with no missing sheets so that they can be bound in the right order as they are on the paper tray. Note that the stack area 112 and the switchback unit can be separately provided.

According to the second and third embodiments, during the continuous printing operation, a print sheet containing a non-normal image is discharged to the first paper tray 81 and its following print sheets are discharged to the second paper tray 82. In other words, there is a missing sheet, the one with a non-normal image, in the stack of print sheets on the second paper tray 82. This is troublesome for a user since the user needs to print the image determined as a non-normal image again after the continuous printing operation and find the right place to insert it in the stack of print sheets on the second paper tray.

On the other hand, according to the fourth embodiment, the following sheet discharge control is performed during the continuous printing operation to discharge a stack of print sheets with no missing sheet on the second paper tray after the continuous printing operation even when one of them with a determined non-normal image is discharged to the first paper tray 81.

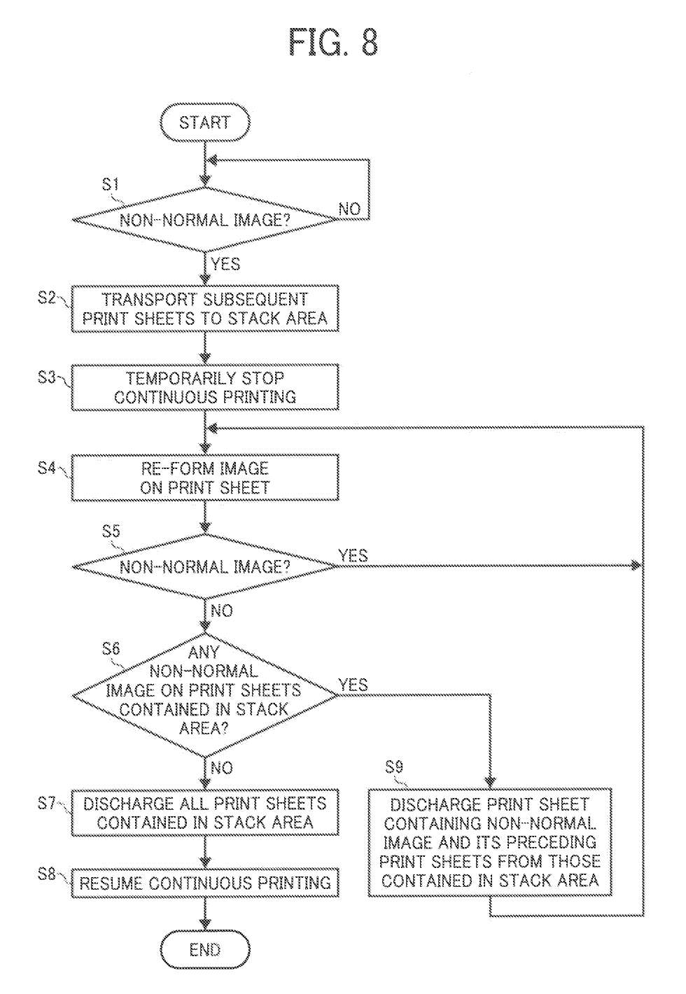

FIG. 8 is a flowchart for the sheet discharge control. In the drawing, when an image on a print sheet is determined to be a non-normal image (YES in step SI), the first switching pawl 87 is switched in a period from when the bottom end of the print sheet passes the first switching pawl 87 to when the top end of a print sheet containing a next image formed reaches the first switching pawl 87, to transport both the print sheets to the stack area 112 (step S2). Print sheets following the one containing a non-normal image are temporarily stacked in the stack area 112. A necessary capacity of the stack area 112 is set to about several sheets although it depends on a printing system. Results of image determination on the print sheets stacked in the stack area 112 are stored in the memories. Further, in step S3 the continuous printing is temporarily stopped after a current formation of an image is completed, and in step S4 the determined non-normal image is formed again on a print sheet. Alternatively, in accordance with a state of image data preparation, the continuous printing is temporarily stopped when several print sheets are printed after the determination of non-normal image. Then, the determined non-normal image is formed again on a print sheet. When the image sensor unit 91 determines the re-formed non-normal image as a normal image (YES in step S5), results of image quality determination on images on print sheets in the stack area 112 are checked in step S6. With all the images determined to be normal images (NO in step S6), the print sheets stacked in the stack area 112 are transported to the discharge path 89 via the re-transport path 113 in order from the bottommost sheet. As in a general feed paper tray, a pickup roller can be provided to contact with a print sheet from below in the drawing, to transport the bottommost sheet first. In step S8 the continuous printing is resumed at a predetermined timing.

On the other hand, when there is a print sheet containing a non-normal image determined among the print sheets stacked in the stack area 112 (YES in step S6), the print sheet containing the non-normal image and its preceding print sheets are transported from the stack area 112 (step S9). Print sheets containing normal images are discharged before the one containing the non-normal image from the stack area 112 to the second paper tray 82, and the print sheet containing the non-normal image is discharged last from the stack area 112 to the first paper tray 81. Also, the image determined as the non-normal image is formed again on a print sheet and the image sensor unit 91 checks whether or not the formed image is a normal image. Upon determining the image as a normal image, the image sensor unit 91 checks the remaining print sheets in the stack area 112 for a sheet containing a determined non-normal image. If there is one, the print sheet containing the non-normal image and its preceding sheets are transported from the stack area 112 as described above, and the determined non-normal image is formed again. Upon completion of discharge of all the print sheets in the stack area 112, the continuous printing is resumed.

Thus, according to the fourth embodiment, even at occurrence of a non-normal image and discharge of a print sheet containing the non-normal image to the first paper tray 81, it is possible to re-form the image again and discharge a print sheet containing the re-formed image in the right order. Accordingly, there will be no missing sheet in a stack of print sheets discharged to the second paper tray 82.

The fourth embodiment is configured to temporarily stack even the print sheet containing the non-normal image in the stack area 112. This is because the distance from the image sensor unit 91 to the first switching pawl 87 has to be set to be less than the length of print sheets in a transport direction. The top end of a print sheet reaches the first switching pawl 87 before the image quality determination is completed. Therefore, image quality on the print sheet is determined while it is delivered to the stack area 112. It can be configured that only the print sheets containing normal images are transported to the stack area 112 while the print sheet containing a non-normal image is discharged to the first paper tray 81, in a case where the distance between the image sensor unit 91 and the first switching pawl 87 can be set to be more than the length of print sheets in a transport direction and the image quality determination is completed before the top end of a print sheet reaches the first switching pawl 87.

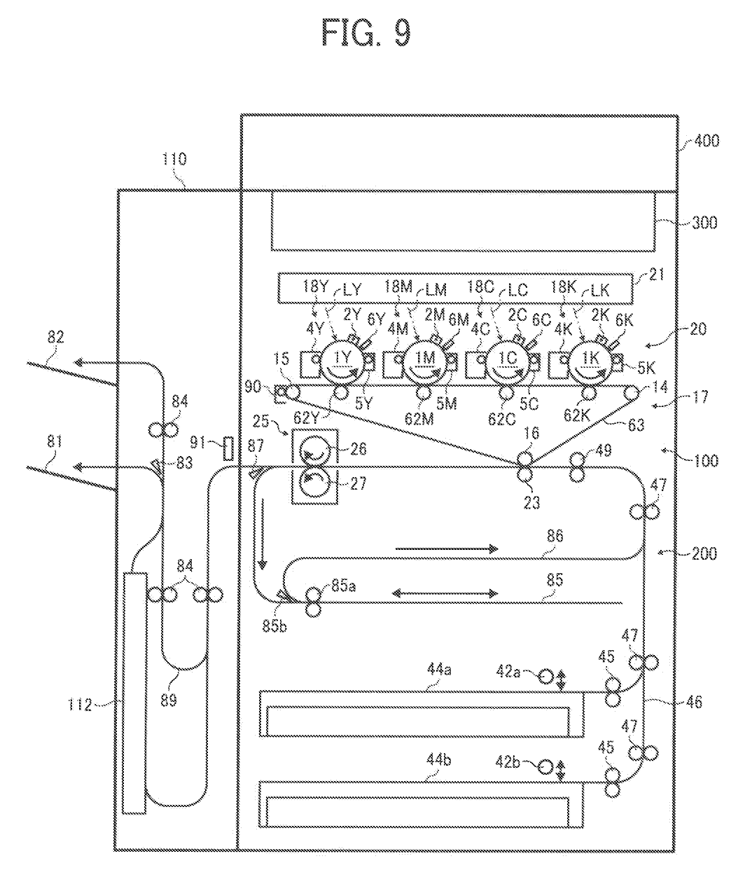

Moreover, the stack area 112 can be provided in the post-processing unit 110 as shown in FIG. 9. This stack area 112 is of a vertical type due to a narrow width of the post-processing unit 110 in FIG. 9. Print sheets are fed not from the bottom end of the stack area 112 but from a portion slightly above the bottom end, so that each print sheet falls to the bottom of the stack area 112 when the bottom end thereof enters the stack area 112. Accordingly, the print sheets are stacked from the left side in the drawing. For re-transporting a print sheet from the stack area 112, a pickup roller is provided to contact with a print sheet from the right side in the drawing, as in a general feed paper tray. Further, the stack area 112 is not limited to one of a vertical type in FIG. 9. It can be of a horizontal type in FIG. 7 when the post-processing unit 110 is large and wide.

### Fifth Embodiment

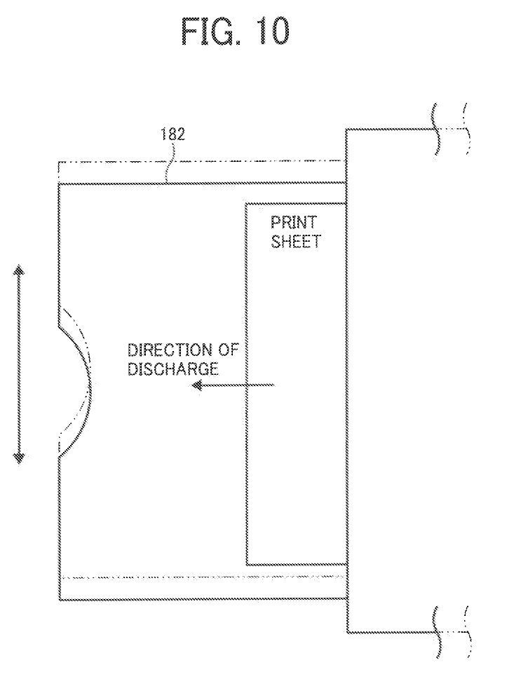

FIG. 10 is an enlarged view of the main feature of an image forming apparatus according to a fifth embodiment. As shown in the drawing, a paper tray 182 is configured to be shiftable in a direction orthogonal to a print sheet transport direction (doggy tail structure). In the present embodiment, when print sheets are discharged to the paper tray 182, a print sheet containing a normal image and a print sheet containing a non-normal image are displaced in a direction orthogonal to the transport direction of the paper tray 182. Specifically, for discharging a print sheet containing a normal image, the paper tray 182 is positioned to be on the solid line in the FIG. 10 while for a print sheet containing a non-normal image, it is moved from the solid line to the dotted line in the drawing. This relatively displaces a positional relation between print sheets discharged and the paper tray 1 82 so that the discharged print sheets with a normal image and with a non-normal image are slightly displaced in a direction orthogonal to a transport direction.

Accordingly, it is made possible to clearly distinct a print sheet containing a normal image and a print sheet containing a non-normal image on the paper tray 1 82. Also, it is possible for a user to easily know which one of sheets includes a non-normal image on the paper tray 182, and reduce a load for finding a non-normal image to be replaced with an additionally printed normal image. Furthermore, there is only one paper tray needed, realizing an effective use of space in the apparatus.

Further, the present embodiment is not limited to the above example. It can be configured to include a diagonal transport roller to contact with a print sheet immediately before discharged and bring the diagonal transport roller into contact with a print sheet containing a non-normal image formed thereon to discharge the sheet on the paper tray 182. Thereby, the print sheet containing a non-normal image is placed in a position on the paper tray 182 different from a print sheet containing a normal image in a direction orthogonal to the transport direction. Alternatively, the discharge roller pairs can be configured to move in the direction orthogonal to the transport direction. The discharge roller pairs supporting a print sheet containing a non-normal image are moved in the direction orthogonal to the transport direction to discharge it to the paper tray 182 in a position displaced from that of a print sheet containing a normal image in the direction orthogonal to the transport direction.

Other various configurations are adoptable as long as print sheets with non-normal images are slightly displaced from print sheets with normal images in the direction orthogonal to the transport direction on the paper tray.

There is another problem in the continuous printing that in a situation that an irrecoverable anomaly is occurring in the image forming apparatus, the continuous printing cannot stop and print sheets containing non-normal images are endlessly discharged to the first paper tray 81, wasting print sheets. To prevent this from occurring, the image forming apparatus is preferably configured to interrupt the continuous printing when a predetermined number of non-normal images are continuously generated in the continuous printing. In such a case, it is also preferable to display or output a message for informing the occurrence of anomaly to a user and enforcedly disable printing. The message can be displayed on an operation panel of the copier or a PC screen connected with the copier.

Moreover, preferably, the memories as a storage unit are configured to store data on image determination so as to fetch a result of image determination when needed. As described above, an image quality is determined by comparing the feature amount of the input image data (estimated color tone value in each area) and that of the output image data (color tone value of detected image in each area). Such a determination result and a reason for the determination can be stored in the memories on the main control board. For example, in a case where color tones differ in one area and the image is determined as non-normal due to a transfer failure in a specific color, the transfer failure in a specific color is stored as the reason for determination in the memory. According to a user's manipulation, a ratio of normal images and non-normal image in printing plural sheets, details of reasons for determining non-normal images or the like can be displayed on a PC screen or an operation panel. This enables a user to know the reasons for determining non-normal images and estimate in which part of the copier is malfunctioning. Such data are usable for maintenance personnel as supplemental data to be able to do maintenance in a shorter time and improve users' satisfaction.

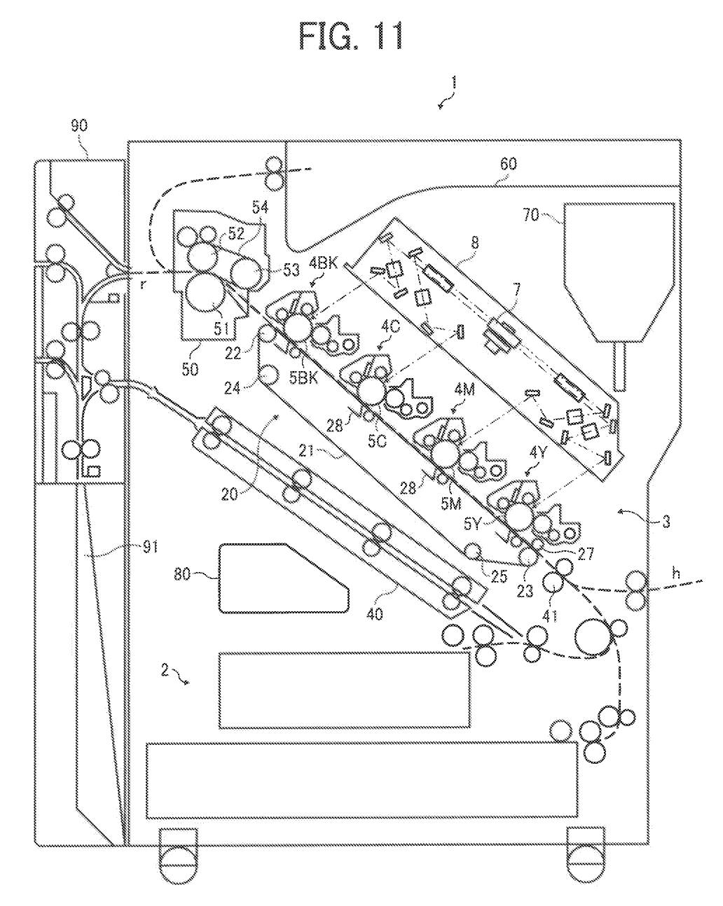

Further, the present invention is not limited to a color image forming apparatus of a tandem intermediate transfer type. It can be applied to a color image forming apparatus of a tandem direct transfer type as shown in FIG. 11, for example.

As described above, the image forming apparatus according to the present embodiment is configured to determine quality of an image on a print sheet (print medium) based on input image data and output image data as a result of detection of an image sensor unit (image detector unit). By using the input image data for reference data, an intended image and an obtained image can be compared with each other for image quality determination. This achieves more accurate image quality determination than one by using data acquired through tests in advance as reference data. Also, it is able to accurately determine quality of images in continuous printing in which different input image data are formed on each sheet.

Moreover, the image forming apparatus according to the present invention comprises the second paper tray (normal print medium receiver) to which a print sheet containing a determined normal image is discharged, the first paper tray (non-normal image print medium receiver) to which a print sheet containing a determined non-normal image is discharged, and the second switching pawl (switching unit) to switch destinations of discharge of a print sheet under transport between the first paper tray and the second paper tray based on a result of determination by the image quality determiner unit. This makes it possible to distinctively discharge print sheets containing the determined non-normal images from print sheets containing normal images. This accordingly eliminates troubles for a user to visually check up outputs and remove ones with defective images, thereby reducing a user's workload and improving their satisfaction with the apparatus. Also, a user can recognize print sheets containing non-normal images without failure since print sheets with non-normal image and ones containing normal images are discharged to different paper trays.

Further, according to the present invention, the distance in which print sheets are transported from the image sensor unit to the second switching pawl is set to be longer than the length of a print sheet in the transport direction which is of a maximum size usable in the image forming apparatus. This accordingly makes it possible to select, after quality of the entire image on the print sheet is determined, an output destination of a print sheet based on the image quality. As a result, it is possible to prevent print sheets containing non-normal images from being discharged to the second paper tray.

Further, the third embodiment of the present invention is configured that in continuous printing, a substitute print sheet (substitute print medium) different in color and/or size from a print sheet is discharged to the second paper tray in replace of a print sheet containing a non-normal image. This makes it easier to identify a missing sheet in a stack of print sheets on the second paper tray, form the image on the missing sheet again on a new print sheet and insert the new print sheet into the stack of print sheets on the second paper tray. This can reduce users' workload and improve their satisfaction with the apparatus.

Further, the fourth embodiment of the present invention is configured that in continuous printing, upon a non-normal image being determined, a print sheet containing the non-normal image and its following print sheets are temporarily stacked on the stack area (temporary stack unit) and the continuous printing is temporarily stopped. Then, after the image determined as a non-normal image by the image quality determiner unit is formed again on a new print sheet and discharged to the second paper tray, the print sheets temporarily stacked on the stack area are re-transported, and the continuous printing is resumed. Accordingly, even with occurrence of a non-normal image during continuous printing, there will be no missing sheets in sheets discharged on the second paper tray. This can eliminate the necessity for users to find a missing sheet and insert a new sheet containing a normal image thereinto. This can reduce users' workload and improve their satisfaction with the apparatus.

Further, the fifth embodiment is configured that print sheets containing non-normal images are discharged to the paper tray in a position displaced from that of those containing normal images in a direction orthogonal to a transport direction. Therefore, it is made possible to clearly distinct print sheets containing normal images and print sheets containing non-normal images on the same paper tray and clearly show the position of the print sheet containing a non-normal image. For replacing the defective sheet with a newly printed sheet, a user does not have to find the position of the sheet to be replaced. This can reduce users' workload and improve their satisfaction with the apparatus. Furthermore, since there is only one paper tray needed, an effective use of space in the apparatus can be realized.

Further, the fifth embodiment is configured that the continuous printing is interrupted when a predetermined number of images are continuously determined as non-normal images by the image quality determiner unit. This prevents print sheets containing non-normal images from being endlessly generated when an irrecoverable anomaly occurs in the image forming apparatus and avoids unnecessary consumption of print sheets to save paper resources.

Further, the input image data and the output image data are each divided into plural areas to obtain the feature amount in each area. The feature amount of the input image data is compared with that of the output image data to determine image quality on a print sheet. This makes it possible to clearly represent the feature of each portion of an image, making it easier to determine image quality. Accordingly, it is possible to reduce a possibility for erroneously determining image quality and to achieve accurate image quality determination.

Further, the image forming apparatus according to the present invention is configured to include the memories as a storage unit in which results of determination by the image quality determiner unit are stored. Thereby, the determination results can be read from the memories at maintenance of the apparatus or the like, making it easier to know the condition of the apparatus, shortening a length of maintenance time, and contributing to continuously maintaining good condition of the apparatus. As a result, users' satisfaction with the apparatus can be improved.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An image forming apparatus comprising:
an image forming unit which forms an image on a print medium based on image data;
an image detector unit which detects the image on the print medium;
an image data obtaining unit which obtains the image data; and
an image quality determiner unit which determines quality of the image on the print medium based on the image data obtained by the image data obtaining unit and a result of detection by the image detector unit.

2. An image forming apparatus according to claim 1, further comprising:
a normal print medium receiver to which a print medium on which an image determined as a normal image by the image quality determiner unit is recorded is discharged;
a non-normal print medium receiver to which a print medium on which an image determined as a non-normal image by the image quality determiner unit is recorded is discharged; and
a switching unit which switches destinations of the discharge of a print medium under transportation between the normal image print medium receiver and the non-normal image print medium receiver based on a result of determination by the image quality determiner unit.

3. An image forming apparatus according to claim 2, wherein
a distance from the image detector unit to the switching unit in which the print medium is transported is set to be longer than a length of a print medium in a transport direction which is of a maximum size usable in the image forming apparatus.

4. An image forming apparatus according to claim 3, further comprising
a substitute print medium container unit which contains a substitute print medium which is different in shape and/or color from the print medium, wherein
the image forming apparatus is configured to discharge, during a continuous imaging operation in which images are continuously formed on a plurality of print media, the substitute print medium to the normal image print medium receiver in replace of the print medium on which the image determined as the non-normal image by the image quality determiner unit is recorded.

5. An image forming apparatus according to claim 3, further comprising
a temporary stack unit in which the print medium is temporarily stacked, wherein
when the image quality determiner unit determines an image as a non-normal image during a continuous imaging operation in which images are continuously formed on a plurality of print media, the image forming apparatus is configured to temporarily stack, in the temporary stack unit, a print medium on which the determined non-normal image is recorded and a print medium on which an image subsequent to the determined non-normal image is formed, temporarily stop the continuous imaging operation, form the determined non-normal image again on a print medium and discharge the print medium to the normal image print medium receiver, and thereafter transport the print media stacked in the temporary stack unit again and resume the continuous imaging operation.

6. An image forming apparatus according to claim 1, wherein
the image forming apparatus is configured to discharge, to the normal print medium receiver, the print medium on which the non-normal image determined by the image quality determiner unit is recorded such that the print medium containing the non-normal image is displaced in a direction orthogonal to a transport direction from the print medium on which the normal image determined by the image quality determiner unit is recorded.

7. An image forming apparatus according to claim 1, wherein
the image forming apparatus is configured to stop a continuous imaging operation when the image quality determiner unit continuously determines a predetermined number of images as non-normal images during a continuous imaging operation in which images are continuously formed on a plurality of print media.

8. An image forming apparatus according to claim 1, wherein
the image quality determiner unit is configured to divide the image data obtained by the image data obtaining unit into a plurality of areas and calculate a feature amount in each area, to divide the image on the print medium into a plurality of areas and calculate a feature amount in each area, and to determine quality of the image on the print medium based on a result of comparison between the feature amount of the image data and the feature amount of the image on the print medium.

9. An image forming apparatus according to claim 1, further comprising
a storage unit which stores a result of determination by the image quality determiner unit.

10. A print media transport device comprising:
a print media transport unit which transports a print medium on which an image is formed;
an image detector unit which detects the image on the print medium;
an image data obtaining unit which obtains image data for forming an image on the print medium; and
an image quality determiner unit which determines quality of the image on the print medium based on the image data obtained by the image data obtaining unit and a result of detection by the image detector unit.

11. An image quality determining method which detects an image on a print medium to determine a quality of the image, comprising the steps of:
forming an image on a print medium based on image data;
detecting the image on the print medium;
obtaining the image data; and
determining quality of the image on the print medium based on the obtained image data and a result of the image detection.
